(19) United States
(12) Patent Application Publication
(10) Pub. No.: US 2011/0127879 A1
(43) Pub. Date: Jun. 2, 2011

(54) Chiral gravitational shielding material

(76) Inventor: Ronald J. Kita, Doylestown, PA (US)

(21) Appl. No.: 12/927,893

(22) Filed: Nov. 29, 2010

Related U.S. Application Data
(60) Provisional application No. 61/283,200, filed on Dec. 1, 2009.

(51) Int. Cl. H02N 11/00; H01F 7/02

(52) U.S. Cl. 310/300; 335/302

(57) ABSTRACT

A gravitational shielding material that is composed of a chiral dielectric as well as a polar or non-polar dielectric matrixing material. Polarization of the dielectric is through the thickness of the material.

### BACKGROUND OF INVENTION

Certain materials have the ability to attenuate the effect of gravity that acts on an object. Such materials are discussed in the patents of Henry W Wallace: U.S. Pat. Nos. 3,626,605 and 3,626,606. Wallace discovered that when certain metals are set into rapid rotation their nucleons are polarized. These metals are the metals that are higher on the periodic table, and usually have an atomic weights of 63 and beyond, also they have the ability to alter gravitation through the act of simple rotation. Copper has the atomic weight of 63 and is composed of 29 protons, 29 electrons and 34 neutrons. Wallace termed these types of materials as odd-atomic nucleide materials. In lower atomic weight metals, the number of protons equals the number of neutrons, but as we ascend the periodic table, we note that the higher atomic number metals have an excess of neutrons when compared to the number of protons. When these higher metals are polarized they give rise to what Wallace called a secondary gravitational field as termed in the title of his U.S. Pat. No. 3,626,605. The secondary gravitational field or “kinemassic” field as termed, has the ability to alter gravitational interaction. When the spin polarized material is placed in gyroscopic set of gimbals and is undulated, a secondary gravitational wave is generated that is not shieldable by currently available materials. These waves that were produced by such action and were detected by a gallium arsenide detector that was placed inside a Faraday Cage. Such a screening device would shield conventional electromagnetic forces if they were of local origin.

The research of Professor Eugeny Podkletnov relates another means of using rotation as a means of altering gravitational attraction by using the rotation of a high temperature superconductor that is placed in a if field. Gravitational reductions of approximately 2% were detected. The research utilizing such devices are usually extremely expensive, and cost in excess of 100,000 USD. for the high temperature superconductive disc preparation are not uncommon. The patent Boris Volfson U.S. Pat. No. 6,960,975 Propulsion Device Utilizing Quantum Vaccum Pressure relates a similar device that utilizes superconductors in combination with rotation to produce such an effect. As previously stated these devices are extremely expensive to produce and the replications of such experiments are most difficult.

There are less costly experimental options involving the spinning of gyroscopes. Professors N A Kozyrev of Russia and Professor Takahashi of Japan seem to have detected minute gravitational shielding events through the spinning of such objects. The effects produced were usually minimal and not of any practical value. In the patent of Haruo Yamashita EP0 486,243A2 spin is also utilized in combination with a charged disc. The disc is placed in an electrostatic shielded container charged then spun, and gravitational attraction is then recorded. Weight changes at the milligram level were detected.

In terms of utilizing superconductive materials without rotation, Professor Raymond Chiao of the University of California-Merced had an article on gravitational reflection published in the Mar. 23, 2009 issue of MIT Technology Review.

It appears that there is a theoretical basis for utilizing SC materials in such a fashion.

High temperature ceramic superconductors that did not have to undergo the stresses of high rotation would be less expensive to fabricate and would require less secondary machinery. The research paper does not describe a specific material, nor does it relate the level of gravitational shielding that can be produced by such a device.

In a web page that can be located by the descriptors: Chiral Eotvos a discussion is provided into the possible attentuation of gravitation or inertia by using chiral materials. Chiral materials are materials that have a three dimensional asymmetry. Example a book by its physical structure is asymmetric, while glove asymmetry is three dimensional. It is the thumb of the glove that exits the normal plane that changes the merely asymmetric geometry into a chiral geometry. In terms of chiral materials or chirality, dextrorotation refers to molecules that have a right-handed asymmetry and levorotation are molecules that possess a left-handed asymmetry.

The discussion of the web page http://www.mazepath.com/uncleal/eotvos.htm relates the Chiral Eotovs Experiment. This experiment examines possibility that chiral materials can be used to modify gravity or inertia. The belief that chiral materials of a very high chirality are required in order to detect any gravitational modification, and only inorganic materials have sufficient of chirality in order to be effective.

It should noted that chirality is determined by the rotation of polarized light passing through a solution of the dissolved chiral matter. Chiral rotations are not limited to only 360 arcuate degrees but inorganic materials having rotations beyond 500 degrees and far be beyond exist. It was Dr Louis Pasteur who seperated odd shaped dextro-tartaric acid from levo tartaric acid and then dissolved them in water while passing a polarized light through the solution. The results were indicated by a deflection of a beam of light that was proportional to the asymmetry of the molecule.

In the Chiral Extvos Experiment, it is posited that only materials possessing a high degree of chirality will have any influence on gravity. In fact, organic materials are dismissed due to their low molecular weight and relatively low optical behavior. The preferred chiral crystals are derived from toxic materials such mercury or tellurium. Even with speculated high chirality it was deemed that only a minuscule attenuation of gravity would be produced. Such low results would only be a scientific curiosity and not of any commercial value.

In experiments replicating the research of Professor N A Kozyrev and also Nick Reiter of the Avalon Foundation http://www.avalonfoundation.org were able to produce small weight changes in sugar crystals as well as tartaric crystals. The effect was produced by aggitating such piezoelectric crystals. It should be noted that chiral materials by their electronic nature are piezoelectric. The weight loss existed until the charges were allowed to recombine; consequently, the weight loss only occurred for a few minutes.

Example: L Tartaric Acid weighting 24.7740 grams upon agitation weighed 24.7735 grams. This reflected a weight loss of 0.5 milligrams, and once again was a material beyond any real world commercial application.

What is of significance is that low molecular weight molecules can be used to modify gravity if there is adequate charging of the material, thus the need for expensive high temperature ceramic superconductor discs is not required. This opens up experimentation and validation of the experiment to the scientific community though an easily replicable series of experiments.

### GOAL OF THE INVENTION

It is a goal of this instant invention to produce a material that is capable of shielding gravitational forces through the use of materials that are chiral in nature.

Also, it is an object of this invention to produce a material for the attenuation of gravitational force by material that is relatively inexpensive to produce.

Another object of this invention is to create a material whose experimental test results are readily reproducible by others.

It is a goal of this invention to take advantage of molecules that are rotational in nature and do not require a mechanical device to set them into rapid rotation.

Another object of this invention is to take advantage of the permanent charging effect as produced by electret materials. A charge is defined as permanent in electret materials when the charge exceeds the useful life of the electret product.

Also it is another goal that such a shielding material have utility in aerospace applications.

### SUMMARY OF INVENTION

A gravitational shield is fabricated by an organic or inorganic material in which the molecule possesses intrinsic rotation. Certain molecules have a structure in which a material appears to be a static solid, yet is comprised of many individual rotation molecules, an example of which is the camphor molecule C10 H 15 0.

Such a material may be combined with another molecule of non-dipolar structure such that when it is in the molten state, placed between parallel conductive plates and energized by a high voltage potential, an electret material is produced

The results is a combination of two effects that are synergistic, thus providing a gravitational shielding effect that is greater than the action of rotation or electrostatic charge alone.

### BRIEF DESCRIPTION OF DETAILED DRAWINGS

FIG. 1 relates a block electrical diagram and,

FIG. 2 relates an orthogonal view of the structure of the gravitational shield and,

FIG. 3 depicts a test mass and it its placement relative to such shield.

### PREFERRED EMBODIMENT OF THE INVENTION

Certain chiral molecules possess intrinsic spin. In a research paper by S O Morgan published by to Bell Telephone Laboratories entitled: Dielectric Evidence of Molecular Rotation in Certain Benzene Compounds, it is noted that the dielectric properties of camphor are sufficiently high to be comparable to the relatively high dielectric constant of many liquids. Upon further examination of the camphor molecule, it was determined that this effect was due to the intrinsic rotation that is possessed by the camphor molecule. This effect is aided by the almost spherical nature of the camphor molecule, yet by virtue of the oxygen molecule camphor has a high dipole moment that renders the molecule chiral and does not detract from the overall rotational structure of the molecule.

There is a distinct advantage of forming a gravity shield from a chiral material and a material that can be charged as to produce an electret. The advantage of an electret is that no power source is needed to maintain charge after the dipoles have aligned and solidified in an electrical field of suitable strength.

According to an article published in a November 1960 issue of the Scientific American by author C L Stong, some of the best electrets are made by using a binary formula comprising 50 percent of rosin and 50 percent carnuaba wax. This compound is comprised of a polar material such as rosin and a relatively non-polar material such as carnuaba wax. Electrical charges are trapped within the electret at the intermolecular interfaces of the dissimilar dipolar materials.

The advantage of a rotational molecule such as camphor in combination with a non-polar Material such as styrene is that the binary compound that is produced is a solid solution. The solid solution will allow the free rotation of the dipolar camphor molecule within the non-polar styrene matrix. Also, an electrical field of suitable strength is required to polarize the binary electret materials as the materials solidify.

Accordingly, this material has the gravitational shielding advantage of having a rotational component and a permanently charged electrostatic component.

It also should be noted that Newtons Law of Universal Gravitational Attraction and Coulombs Law of Electrostatic Attraction are very similar in nature.

In Newton formula for gravitation, attraction is a product of the weight of the two masses and the force produced is inversely proportional to the distance between the two masses. Coulombs Law of Electrostatic Attraction can be written as the Newtons Law of Gravitation simply by replacing the term “in” for mass with term “q” for charge.

Professor R C Gupta at the Institute of Engineering and Technology in Luckow, India wrote a paper entitled: Gravity as the Second-Order Relativistic Manifestation of Electrostatic Force. The goal of this research paper is to link gravitational forces with electrostatic forces. The paper concludes that gravity is the most common force around us, but unfortunately there is no simple and clear explanation for it. A simple and clear alternative explanation is proposed in the present paper. Contrast to Einstiens general relativity-based explanation of gravity, the explanation of the author is based on special second-order relativistic manifestation of electrostatic force on somewhat similar lines as magnetism is a relativistic effect of electricity. The proposed theory is well in accordance with gravity-based behavior as stated by Newton having features quite similar to its origins in the electrostatic force equation as developed by Coulomb. This provides a possible link for the uniting of the forces of gravity with forces that are electro-static in nature. This new interrelationship depicts gravitation as a second order electromagnetic phenomena and gravitational attraction; consequently, the curvature of the space-time geodesic is due to electromagnetic interaction. This paper by Guspta was from the 2006 era with the exact date not specified. Dr Abdus Salam of the ICTP Trieste, Italy is formerly acknowledged for his contribution.

It should be noted it is not the object of this invention as to be held to or formally endorse a theory of gravitational interaction or the lack of interaction thereof, but merely produce a material that alters or attenuates gravitational forces by utilizing easily reproducible experiments that are well known and can be confirmed by the scientific community at little or modest cost.

The basic structure of the gravitational shield is produced in a vessel that capable of holding a molten or liquified dielectric material. The walls of the vessel are constructed of a material that is not capable of dielectric breakdown when the dielectric contained in the vessel is exposed to a high voltage electric field from a pair of affixed electrodes.

Accordingly, the high voltage is only used to polarize the dielectric until the dielectric has polymerized or solidified.

The technology to produce an electret material is discussed in an article in the Scientist American as previously stated.

The dielectric material comprises a dielectric that is rotational solid such as camphor. Dextrorotatory camphor has a chirality of 44 arcuate degrees; however if d-camphor undergoes an addition reaction with chlorine, it thus becomes chlorocamphor the dipole moment of the camphor is increased and the chirality of the chlorocamphor is 71 arcutes degrees. It also should be stated that electrets are the electrostatic equivalent of the permanent magnet and fabrication theory is very similar in nature. Electrets are usually of two varieties: homocharged electrets and heterocharge electrets. This convention as to their description is derived by the nature of the charges produced on the surface of the electret. In accordance to electrical theory, when an electrode is applied to a surface, the surface that is opposite of the electrode will develop an opposite charge relative to the charge on the electrode. This is called a heteroelectret. A homoelectrets is produced in a similar manner and the initial charges on the surface of the electrode are the same are the heterocharged electret, but upon removal of the electrodes the charge on the electret material will decrease to zero then return with a charge that results in the surfaces of the electret now having the same charge as the initial electrode produce on the surface; hence the term homoelectret.

While a gravitational shielding material may be produced by a unitary material, a binary formula or formula comprising two different or similar materials are most advantageous in terms of storing a high degree of electrostatic charge over a long period of time. In this case, the dielectrics may be a halogen-substituted camphor such as chlorocamphor that is combined with a styrene monomer or the like. This formula takes advantage of the relative high chirality of the chlorocamphor as well as its unique rotational properties. Styrene is non-polar and is the basis of many homocharged electrets, but the combination of these two materials produces an enhanced effect on gravitational attenuation. The ratio of combination of these material may be 50-50%.

While this formula relates a specific combination of materials there are other rotational molecules such as but not limited to camphenes, fenchone, borneol, terpenes and the like, that may be used in their original state of may be halogenated with bromine, chlorine, fluorine or iodine. Such halogenation results in an increase in chirality and in many cases an increase in the dipole moment of the material. Matrixing materials may be of a polar of non-polar material such as: styrenics, acrylates, waxes, oils, polyesters and other dielectric materials. While solid dielectrics are preferred, liquids can be utilized as long as a polarizing voltage is maintained on the dielectric material.

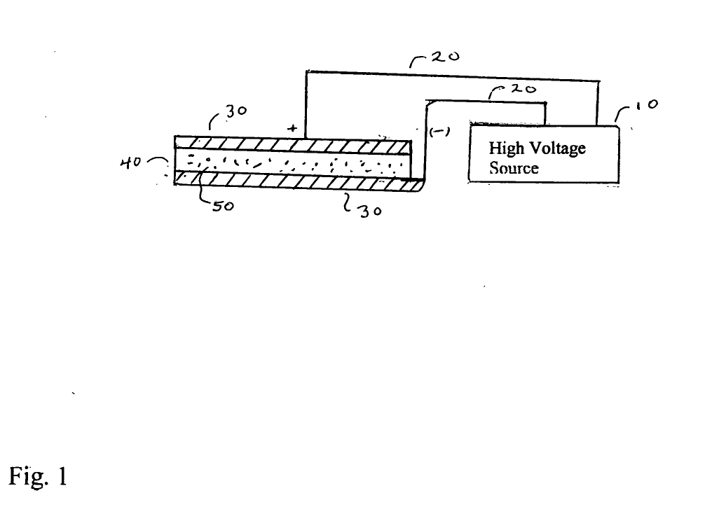

In FIG. 1 a high voltage source 10 is connected via electrical leads 20 to electrodes 30a and 30b that are located on opposite sides of vessel 40. When a dielectric material 50 in liquid or molten form is placed into the vessel the polarized voltage from the high voltage source 10 contacts the liquid or molten dielectric 50. Electrical leads 20 are connected to electrodes 30a and 30b until thermal solidification of the dielectric material 50 solidifies or until the dielectric material polymerizes into a solid after which electrodes 30a and 30b can be removed. In some cases when an electret is formed it is to be wrapped in an aluminum foil as to maintain the charge. This is similar to the use of a keeper that was used to entrain magnetic forces within horseshoe-shaped magnets that were fabricated from relatively soft ferrous materials.

In the fabrication of such shielding materials, it is important that the voltage that is used to polarize the aforementioned group of molecules not exceed the voltage to the point of dielectric break down. Such dielectric breakdown is similar to the effect as produced by the dielectric breakdown in a capacitor and is deleterious to the formation of an electret-like material since at this point the electrical field is no longer providing an electrical stress in polarizing the molecule.

While the materials that are discussion are electret-like in formation, there is the possibility that such materials that are aromatic or cyclic in nature are actually degenerate non-bulk superconductors. The term non-bulk superconductor was coined by Dr Freeman Cope Head of Research at Johnsville Naval Air Station, Warminister, Pa. After examining various cyclic and aromatic hydrocarbons that possessed electrical ring currents, he came to the conclusion that while no overall superconductive was exhibited over the bulk of the material there existed microscopic areas of non-linked superconductivity, and such materials when tested exhibited Barkhausen Noise, indicator of regions of superconductivity.

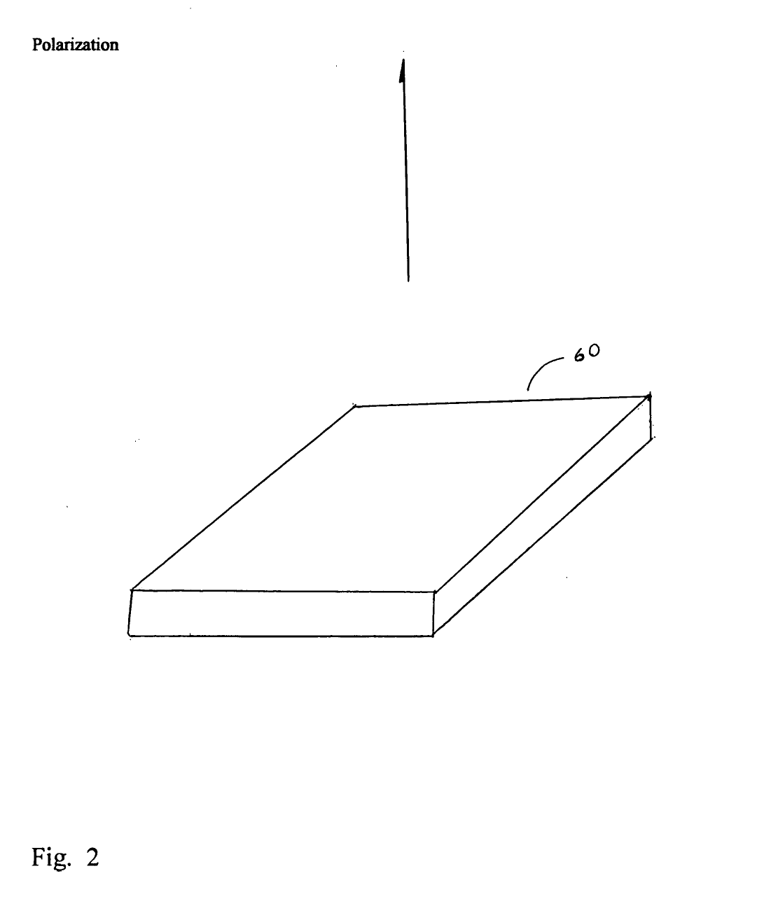

FIG. 2 represents a frontal view of the gravitational shield 60 and it is to be noted that the polarization of dielectric material 40 is through-the-thickness of the material. The shape of vessel 30 is rectangular and electrodes 20 are disposed on either sides of the vessel 30. Approximate dimensions of the vessel are 6.0 inches by 6.0 inches with a thickness of 0.25 inches. The dielectric 40 is a combination of chlorocamphor with a matrixing styrene monomer. Both the chlorocamphor along with the monomer is heated to the melting point of the chlorocamphor or 94 degrees celsius. A catalyst such as an organic peroxide is used to polymerize the dielectric. In this situation a methyl ethyl ketone peroxide is utilized at concentrations of 1 percent. If a wax such as carnuaba is used polymerization consideration do not have to be met, rather the binary dielectric compound is heated to the melting point of both materials, then mixed and allowed to solidify in the electric field. After solidification the leads that supply electrical power to the electrodes may be removed.

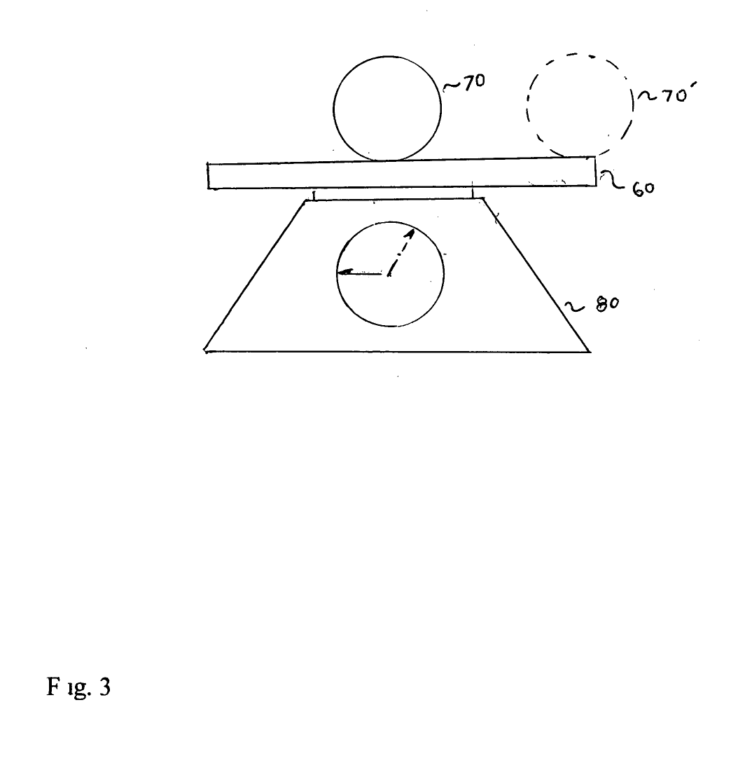

In FIG. 3 a frontal view of the gravitational shield is presented along with a spherical test mass 70. The greatest gravitational shielding effect is detected by test mass 70 when the object is located in the center of the shield; and as the spherical metallic test mass is moved to the edges of the shielding material the shielding effect is lessened accordingly. Readings from a digital or mechanical scale 80 can be used to determine the degree of gravitational shielding. A mechanical scale is preferred since minute electrostatic voltages emanating from the electret-like material can thus influence the digital read-out. The detection of an electrostatic field emanating from an electret-type material is far more difficult to detect than a magnetic field emanating from a permanent magnet. Electrostatic field produced by such materials are usually feeble and can be detected by very sensitive instruments; however, as a section of a conductive foil moves through the electrostatic field, it will produce a slight voltage and in some instances can produce a spark.

Also when electret materials are returned to their molten state, tapped or induced charge are no longer seperated or orientated and the material will no longer function as a gravitational shield.

It should also be noted that energy from a electrical source such as transformer or a mechanical high source such as a Wimhurst Machine are also suitable as means of polarization such dielectrics. Other polarization sources for the dielectrics can be: electromagnetic fields or magnetic fields emanating from a permanent magnet likewise can be employed.

In addition, it should be noted that camphoric materials such as camphor are representative of a class of molecules called ketones. Another class of material possessing chiral properties are terpenes, and representative of this group is abietic acid. Due to the nature of abietic acid the degree of chirality can vary, as do similar turpentine-like materials. In this class materials levorotations of 106 arcuate degrees are possible.

Also of use as matrixing dielectric are materials of the benzene series: benzene, naphthalene, anthracene and the like as well as their substituted derivitives such as chloronaphthalene, as an example.

Mixing ratios of the various aforementioned dielectrics can be 50:50 or 5:95 parts per hundred, as an example.

It should also be noted that in the teaching of this specification that there are other embodiments of this invention that are envisionable by one skilled in the art, and that these specifications should not be construed as limiting of restricting as to the scope of the invention.

What is claimed is:

1. A gravitational shielding material comprising: a dielectric, a polarization field, a a plurality of electrodes.

2. The gravitational shielding material of claim 1 in which the polarization field is an electrostatic field.

3. The material of claim 1 in which the polarization field is magnetic.

4. The material of claim 1 in which the polarization field is electromagnetic.

5. A gravitational shielding material comprising a chiral material, a plurality of electrodes and a polarization field.

6. The material of claim 5 in which the chiral material is a ketone.

7. The material of claim 5 in which the chiral material is an abietic acid.

8. The material of claim 5 in which the chiral material is a terpene.

9. The dielectric in claim 1 in which the dielectric is a subsituted benzene series molecule.

10. The dielectric in claim 1 in which the dielectric is a chloronaphthalene.
